(19) United States
(12) Patent Application Publication
(10) Pub. No.: US 2004/0182922 A1
(43) Pub. Date: Sep. 23, 2004

(54) Systems and methods for a loadable stored-value card with a contribution to a specified beneficiary

(76) Inventor: Frank Talarico JR., Yorba Linda, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/804,686

(22) Filed: Mar. 19, 2004

Related U.S. Application Data
(60) Provisional application No. 60/456,991, filed on Mar. 21, 2003.

(51) Int. Cl. G06F 17/60; G06K 5/00

(52) U.S. Cl. 235/380

(57) ABSTRACT

Systems and methods are disclosed that allow a cardholder of a loadable stored-value card to load monetary funds into an account associated with the card. An issuer of the card credits a specified portion of the loaded value to a designated charity or other beneficiary identified by the cardholder. The card may be used to pay for goods, services, and other transactions in a manner similar to that of a debit card or a pre-paid card. The portion provided to a specified beneficiary may be calculated as a specified percentage or other portion of the monetary value that is loaded onto the card. The stored-value card may also be reloaded with value in order to replenish the available monetary funds for spending using the card, thereby also providing additional funds to the specified beneficiary.

### PRIORITY APPLICATION

This application claims priority benefit of U.S. Provisional Patent Application No. 60/456991 filed Mar. 21, 2003, titled “LOADABLE/RELOADABLE STORED-VALUE CARD WITH A CONTRIBUTION TO CHARITY,” which is incorporated herein by reference in its entirety.

### BACKGROUND OF THE INVENTION

1. Field of the Invention

The present invention relates generally to the field of monetary transfers, and more particularly to a loadable stored-value card instrument that provides a portion of the loaded value to a specified fundraising beneficiary.

2. Description of the Related Art

Philanthropy and charitable giving in the United States have reached an annual level of close to $200 billion. Most of this funding is from corporations, foundations, and estates that focus on higher education, health care, and support of individual religions. Elementary and secondary schools and other non-profit organizations often receive less funding than higher education and health care. As a result, some schools and organizations have turned to fundraising projects, such as product sales and charitable events, to supplement their budgets. Traditional product sales and charitable events often distract students, teachers, and parents from their primary tasks and on occasion have even resulted in financial loss. Such fundraising efforts may become a significant time and resource burden.

In recent years, schools have used paper scrip (i.e., a discounted retail merchant gift certificate) as a method of fundraising. This method is based on a school buying a volume of scrip gift certificates from a particular merchant at a discounted price with an intent to sell the scrip at full face value. The volume purchase discount becomes the profit for the school. Currently, the largest company using such a paper scrip fundraising method is the National Scrip Center.

The paper scrip method is often cumbersome for the parties involved. It can be inconvenient for purchasers of paper scrip and is limited in its ability to maximize the participation and return on spending with merchants. The beneficiary (e.g., the fundraising school) often pays for the paper scrip in advance at a select group of merchants, hoping that they have purchased the correct amount and denominations of scrip to meet, but not greatly exceed, the need of the purchasers. In some programs, purchasers purchase paper scrip at the school prior to shopping, thereby adding more time to a shopping trip. Purchasers hope they have correctly predicted their anticipated spending for each merchant but may not succeed in doing so, and any amount spent at a merchant with cash rather than with paper scrip does not result in a donation. In addition, merchants often record each certificate manually and audit the system, school by school, church by church, etc., which may result in a delay of donation funds that are to be remitted to the school. Lastly, the amounts that benefit the school are often not tax deductible by the scrip purchaser.

Another method used for generating charitable donations involves the use of a suitably configured credit card for which a merchant, card-issuing bank, cardholder, or other interested party agrees to donate a specified amount per credit card purchase to a designated beneficiary. A credit-card-based system has several disadvantages. For one, individuals wishing to participate in the credit card/donation system apply and are approved or denied as they would be for other credit cards, based on their assessed credit-worthiness and on other relevant factors. Thus, individuals who wish to donate, but do not qualify for the credit card, are not able to participate in the program. Also, cardholders that qualify may be asked to pay various annual and monthly fees and charges. Furthermore, although a potential donor may desire to donate to the designated charity and may successfully apply for a card, no monies are credited to the charity until the cardholder actually uses the card to pay for a transaction. In some systems, no funds are credited to the charity until the cardholder pays the credit card bill for the transaction. Finally, some charitable organizations are reluctant to encourage their members and donors to become more deeply involved with credit card spending on their behalf.

The present invention seeks to overcome these and other problems.

### SUMMARY OF THE INVENTION

Systems and methods are disclosed that allow a cardholder of a loadable stored-value card to load monetary funds into an account associated with the card. An issuer of the card credits a specified portion of the loaded value to a designated charity or other specified fundraising beneficiary identified by the cardholder. The fundraising beneficiary may be associated with a non-profit entity, a for-profit entity, a family member, the cardholder him or herself, or any of a variety of funds to which the cardholder wishes to contribute. The loaded card may be used to pay for goods, services, and other transactions in a manner similar to that of a debit card or a pre-paid card. The donated portion may be calculated as a specified percentage or other portion of the monetary value that is loaded onto the card. The stored-value card may also be reloaded with value in order to replenish the available monetary funds for spending using the card, thereby also donating additional funds to the specified beneficiary.

Embodiments of a method for facilitating donations from a population of participants to a specified fundraising beneficiary are described. For each of a plurality of members from the population of participants, the method comprises: (a) providing the member with a loadable stored-value card that is associated with the member and that is usable by the member, when loaded, to make purchases of goods and services from vendors, and (b) associating the loadable stored-value card with an account within which funds of the member may be stored and withdrawn. In response to a request received from a member, the method further comprises: (c) placing funds in the member's account, thereby loading the member's loadable stored-value card with a first value, and (d) providing from the member's account a second value to the specified fundraising beneficiary.

A system for facilitating donations to a specified fundraising beneficiary by a population of participants is described. The system comprises a plurality of member accounts that are associated with (i) a member, and (ii) a stored-value card that is associated with that member and that is usable generally by the member to make purchases of goods and services from vendors. The system further comprises an interface for receiving requests from members of the population of participants and a stored-value card processor that, in response to a request from a member: (i) provides funds into the member's account, thereby loading the member's stored-value card with a first value; and (ii) provides a second value to the specified fundraising beneficiary from the member's account.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages taught or suggested herein.

### BRIEF DESCRIPTION OF THE DRAWINGS

Various other objects, features and attendant advantages will become fully appreciated as the same becomes better understood when considered in conjunction with the accompanying drawings. The drawings and the associated descriptions are provided to illustrate embodiments of the invention and not to limit the scope of the invention. Like reference characters designate the same or similar parts throughout the several views.

FIG. 1 is a diagram illustrating a front side of one embodiment of a loadable stored-value card.

FIG. 2 is a diagram illustrating a back side of one embodiment of a loadable stored-value card.

FIG. 3A is a flowchart illustrating one embodiment of a process for using a stored-value card system to provide a charitable donation to a cardholder's selected charity or charities based on value loaded to the card.

FIG. 3B is a flowchart illustrating one embodiment of a process for accepting an enrollment form for a stored-value card.

FIG. 3C is a flowchart illustrating one embodiment of a process for creating accounts and database records for new cardholders 405.

FIG. 4 is a block diagram illustrating one embodiment of a system for issuing, maintaining, and administering a stored-value card.

FIG. 5 depicts a simplified example of one embodiment of an individual charitable contribution report.

FIG. 6 depicts a simplified example of one embodiment of a group charitable contribution report.

### DETAILED DESCRIPTION OF PREFERRED EMBODIMENT

Systems and methods are disclosed that allow a cardholder of a loadable stored-value card to load monetary funds into an account associated with the card, with an agreement that an issuer of the card will, in response, credit a portion of the loaded value to a specified charity or other beneficiary designated by the cardholder. The loaded card may be used to pay for goods, services, and other transactions in a manner similar to that of a debit card or a pre-paid card.

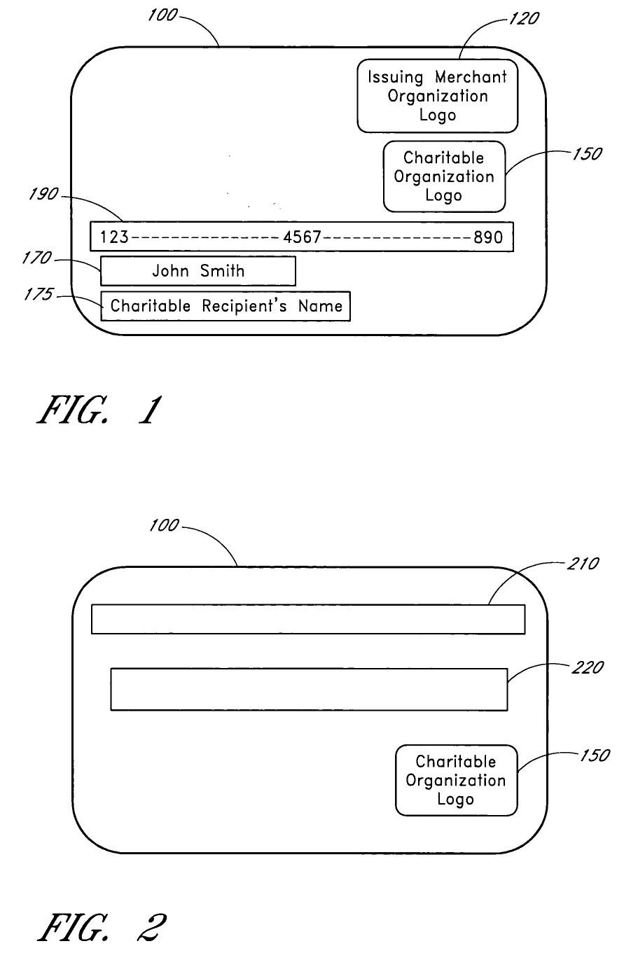

The donated portion may be calculated as a specified percentage, a fixed amount, or other portion of the monetary value that is loaded onto the card. The donated portion may be directed to one or more beneficiaries specified by the cardholder, such as charitable concerns, schools, community groups, other not-for-profit and for-profit funds, retirement savings accounts, educational accounts, and the like. Although, for ease of explanation, the FIGS. 1-6 depict embodiments in which the specified beneficiary of the stored-value card is a charitable concern, these depictions are presented as examples and are not meant to limit the scope of possible specified beneficiaries.

Loading refers to a process whereby a cardholder authorizes a transfer of funds into an account associated with a stored-value card. The card is thereby authorized to be used for payment of future purchases, up to the amount of the loaded value. When the cardholder presents the card to a merchant as payment for a purchase, funds to cover the amount of the purchase are transferred from the account to the merchant's account. The amount of funds transferred is accordingly debited from the account associated with the stored-value card. Optionally, the stored-value card may also be reloaded with value in order to replenish the monetary funds for available for card transactions, and to thereby also donate additional funds to the specified beneficiary.

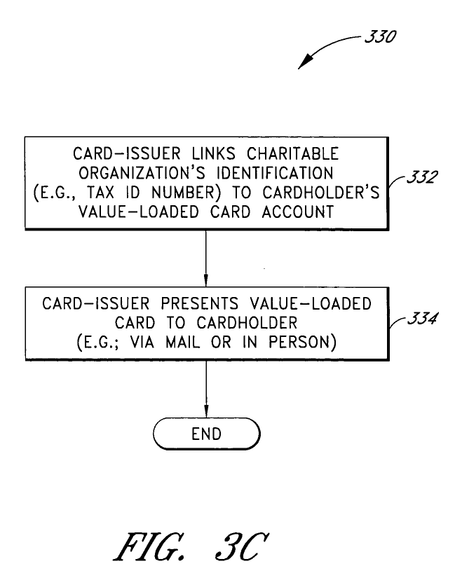

A general architecture for one embodiment of a stored-value card system that shows relationships amongst cardholders 405, a card-issuer 425, merchants 435, and a charitable organization 430 is depicted in FIG. 4. The figure further depicts a special account 440 associated with the stored-value card, a database 420 of information about the stored-value card accounts, and a third party stored-value card processing center 415 that may process card-related transactions for the card-issuer 425, as will be described in greater detail with reference to FIG. 4.

In one embodiment, the stored-value card is issued by a bank 425 that identifies and pays the contribution to the one or more specified beneficiaries 430. In another embodiment, the bank 425 contracts with a third-party processing center 415 to administer and manage the stored-value card system. A value-load processing method enables the bank to pay the proper amount to a designated charity 430 or other beneficiary as well as to report the donated amounts to both the individual and to the charitable concern 430.

FIG. 1 illustrates a front side of one embodiment of a loadable stored-value card 100. In various embodiments, the stored-value card 100 may be issued by a bank acting as an agent for a card-issuing organization, such as VISA. As shown in FIG. 1, the front face of the card 100 may comprise an emblem 120 or trade name associated with the card-issuing organization, an account number 190 assigned by the issuer to the cardholder 405, and the cardholder name 170. In addition to the above terms, a logo 150 and/or charitable recipient's name 175 may be placed on one or both sides of the card 100 to remind the stored-value cardholder 405 that loading the card 100 with monetary value will result in a charitable donation to the identified recipient 430. In addition, the front of the card 100 may be visually customized according to the requirements of the charitable organization 430. Customization may drive incremental usage due to affinity.

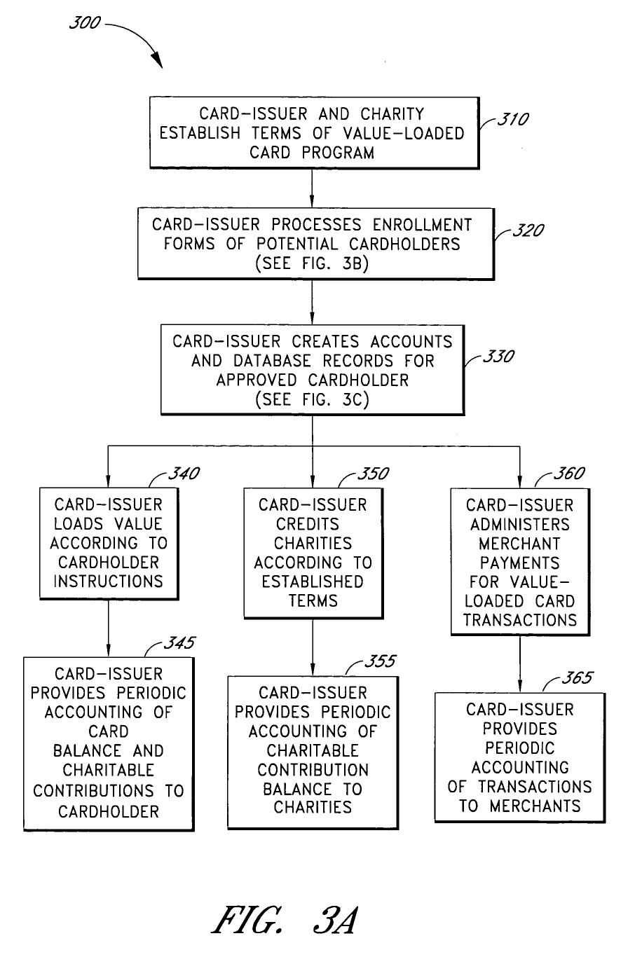

FIG. 2 illustrates a back side of one embodiment of a loadable stored-value card 100. The back side of the card 100 includes account identification 210, preferably via a magnetic strip containing magnetically encoded account identification. The back side of the card 100 preferably further includes a separate non-magnetic strip for the cardholder signature 220, and may include the logo 150 of the charitable organization. Information about the designated beneficiary and about the specified percentage to be donated may be stored in the magnetic strip 210 or may be stored remotely by the card-issuer 425 or a third-party operating in its behalf to administer the loadable stored-value card system.

The loadable stored-value card 100 is designed to be compatible with conventional purchasing systems designed to work with credit cards, debit cards, and the like. Accordingly, the loadable stored-value card 100 may be used to make purchases at vendors 435 in the same manner as a VISA or MASTERCARD or bank debit card. In one embodiment, the loadable stored-value card 100 is associated with a personal identification number (“PIN number”) known to the cardholder 405. When making a purchase, the cardholder 405 may swipe the loadable stored-value card 100 through a card reader and enter the secret PIN number in order to access the value loaded onto the loadable stored-value card 100. Alternatively, the loadable stored-value card 100 may function like a credit card, wherein no PIN number is required. If no PIN is required, the merchant's 435 system typically will make an inquiry to the card-issuer 425 (using information stored on the magnetic strip 210 of the loadable stored-value card 100) to verify that sufficient finds are available to cover the purchase amount.

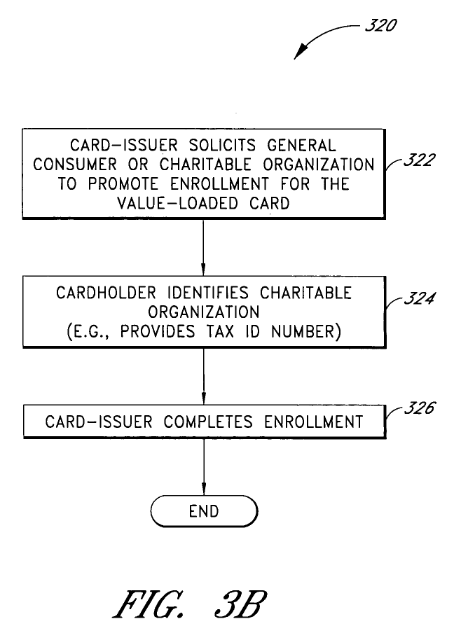

FIGS. 3A, 3B, and 3C illustrate various aspects of a process for using a stored-value card system to provide a charitable donation to a cardholder's selected charity or charities based on monetary value loaded to the card. It is to be understood that while the flowcharts of FIGS. 3A, 3B, and 3C describe a variety of functions that are executed by the card-issuer 425, the functions may, in various embodiments, be executed by a third-party stored-value card processing center acting on behalf of the card-issuer 425. Similarly, the flowcharts of FIGS. 3A, 3B, and 3C describe the stored-value card 100 as providing donations to a charitable organization 430. The stored-value card system may also be implemented to provide funds to other types of designated beneficiaries, including schools, educational programs, religious or other affinity groups, and savings funds such as educational finds.

FIG. 3A is a flowchart illustrating one embodiment of a process 300 for using a stored-value card system to provide a charitable donation to a cardholder's selected charity or charities 430 based on monetary value loaded to the card 100.

Initially, as depicted by Block 310, a card-issuer 425 and a charitable organization 430 agree on terms for a stored-value card program for generating donations to the charitable organization 430. The card-issuer 425 may verify the suitability of the charitable organization 430 to participate in the program, for example, verifying the organization's non-profit or tax-deductible status. Terms of the program may include numbers of participants that the charity 430 agrees to bring to the program and rebate amounts that the card issuer 425 agrees to credit to the charity upon loading of an associated stored-value card 100. In various embodiments, details of the agreed upon terms may vary to suit the preferences of the charitable concern 430 and of the card-issuer 425. In some embodiments, the card-issuer 425 and the charitable organization 430 may not set a fixed percentage donation for cardholders that designate the charitable organization 430 as their beneficiary. Instead, cardholders 405 may optionally be allowed to set their own preferred rate of donation and may further optionally be allowed to change the rate, if desired, upon reloading of the card. The card-issuer 425 may optionally specify a minimum acceptable percentage for participation in the stored-value card program. Preferably, each time the cardholder 405 loads value onto the card 100, he or she is informed of the size of the associated contribution, the beneficiary of the contribution, and the account of the cardholder 405 from which the donation was provided.

Some fundraising entities are associated with a population of participants that are required to donate predetermined amounts of money over predetermined periods of time. For example, families of students in a school may be required to meet minimum donation requirements for the school each semester. In such circumstances, the card 100 disclosed herein allows a cardholder 405 to have great control over the timing and amount of his or her donation, thus ensuring that the donation requirements of the associated fundraising entity are satisfied. Because the donation is associated with the loading of the card 100, rather than the use of the card 100 to make a purchase, the cardholder 405 will never feel compelled to make a purchase of a particular size, or at a particular time, or at a particular store, merely to satisfy a donation requirement of the fundraising entity.

As depicted by Block 320, once suitability has been determined and a relationship contract agreed upon by the card-issuer 425 and the charitable concern 430, the card-issuer 425 enrolls cardholders 405 that wish to receive a stored-value card for donating to the charitable concern 430. For example, if the charitable concern 430 is a school, the card-issuer 425 may enroll cardholders associated with families with students in that school. The process of enrolling cardholders 405 is described in greater detail with reference to FIG. 3B.

As depicted by Block 330, the card-issuer 425, or a third-party stored-value card processing center 415 working on behalf of the card-issuer 425, creates accounts 440 and/or database records 420 for approved cardholders 405, as is described in greater detail with reference to FIG. 3C. The accounts and/or database records 420 may be used in the management and record-keeping of the cardholders' accounts 440. Approved cardholders 405 may be provided with unique identifiers (such as personal identification numbers) to facilitate secure communications between the cardholder 405 and the card-issuer 425.

Once accounts 440 have been established for new cardholders 405, the card-issuer 425, or a third-party 415 working on its behalf, carries on the process 300 with cardholders 405, with the charitable concerns 430 or other specified beneficiaries, and with merchants 435 who accept payment from cardholders 405 using the stored-value cards 100.

Blocks 340 and 345 relate to the card-issuer's 425 activities with respect to the cardholder 405. As described in Block 340, the card-issuer 425 loads the account of the stored-value card 100 according to instructions and funds received from the cardholder 405 so that the cardholder 405 may use the card 100 as payment for goods and services and may make a donation to the designated charity 430. The cardholder 405 may authorize the loading of monetary value onto the stored-value card 100 using a variety of technologies and methods, as will be described in greater detail with reference to FIG. 4.

Once additional funds are loaded by the cardholder 405, the card-issuer 425 updates records 420 for the cardholder's associated account 440 to reflect the newly-loaded value. The cardholder 405 is now free to use the card 100 as a pre-paid payment mechanism for the purchase of goods and services.

As will be described in greater detail with reference to Block 350 and Block 360 of this figure, the card-issuer 425 also manages the transfer of funds to pay the agreed-upon donation to the charitable concern 430 and to pay merchants 435 in response to purchases made using the card 100.

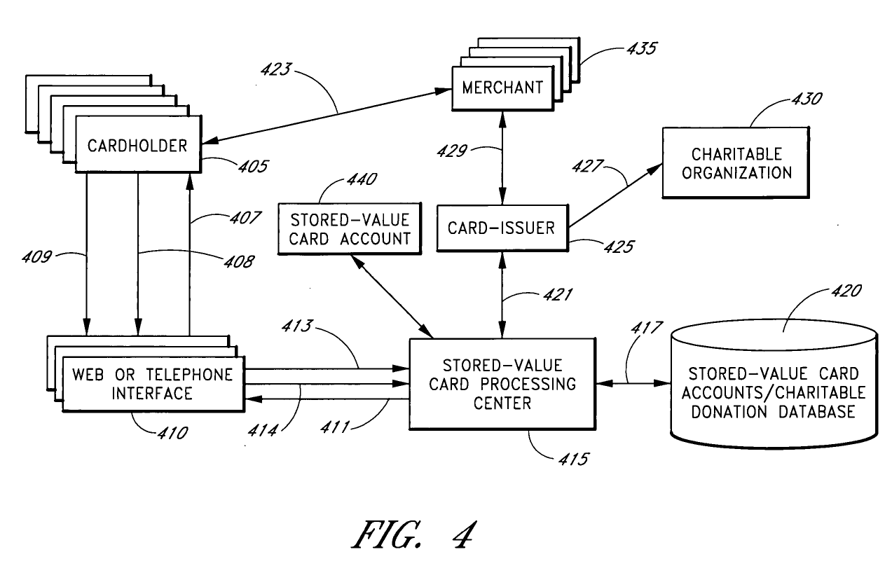

As depicted in Block 345, the card-issuer 425 may provide the cardholder 405 with a periodic report regarding activity associated with the cardholder's stored-value card 100 for a given reporting period. For example, the report may comprise an accounting of value loaded onto the card 100 during the reporting period as well as donations made to the cardholder's designated charitable organization 430 on behalf of the cardholder 405. In some embodiment, the report may provide the current balance of value loaded onto the stored-value card 100 and/or information about individual stored-value card transactions. FIG. 5 depicts one example of a periodic report sent by the card-issuer 425 to the cardholder 405 and will be described in greater detail below.

Blocks 350 and 355 relate to the card-issuer's 425 activities with respect to the charitable organization 430 or other specified beneficiary. As depicted in Block 350, when a stored-value card 100 that designates the charitable organization 430 as its specified beneficiary is loaded or reloaded with funds, the card-issuer 425 credits the charitable organization 430 according to the agreed upon terms. For example, if the terms provide for a donation equal to 3% of the loading value, a cardholder loading $100 onto his or her card 100 causes a $3 donation to go the charitable organization 430. Accordingly, in one embodiment, the cardholder's account (from which funds are drawn) is decreased by $103. In another embodiment, the $3 donation may be deducted from the $100, so that the value loaded onto the card and available for use in purchases is $97. The card-issuer 425 may credit the charitable organization 430 by sending a check for the rebate amount, by electronically crediting an account associated with the charitable organization 430, or by other methods that will be familiar to one of ordinary skill in the art. The card-issuer 425 may credit the charitable organization 430 when an associated card 100 is loaded. In other embodiments, the card-issuer 425 may periodically credit the charitable organization 430 for donations that have accrued as a result of cardholders 405 loading their stored-value cards 100 during a current period.

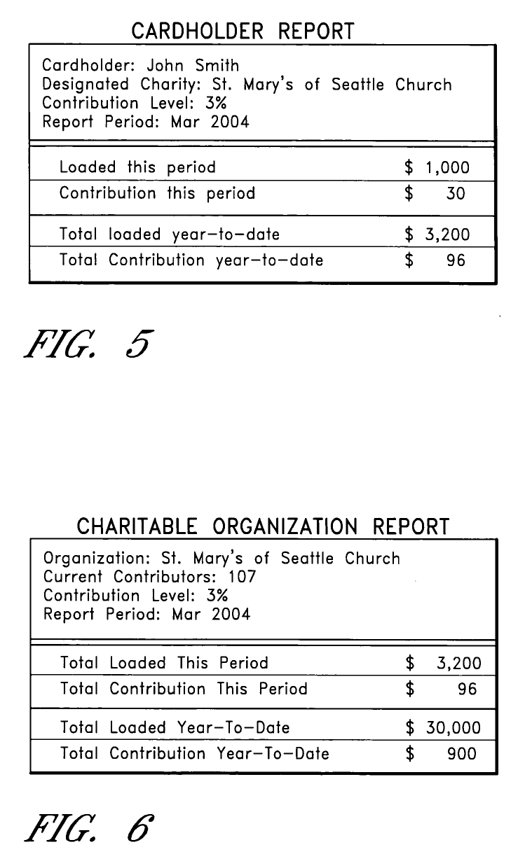

As depicted in Block 355, the card-issuer 425 may provide the charitable organization 430 with a periodic report regarding activity associated with stored-value cards 100 that designate the charitable organization 430 a specified beneficiary. For example, the report may comprise an accounting of value loaded onto cards 100 that designate the charity 430 during the reporting period, as well as an accounting of the amount credited to the charitable organization 430 on behalf of the cardholders 405. The report may provide, additionally or alternatively, year-to-date information regarding funds credited to the charitable organization 430. FIG. 6 depicts one example of a periodic report sent by the card-issuer 425 to the charitable organization 430 and will be described in greater detail below.

Blocks 360 and 365 relate to the card-issuer's 425 activities with respect to merchants 435 who have accepted the stored value card 100 as payment for services and/or goods rendered. As shown in Block 360, the card-issuer 425 administers merchant payments for stored-value card 100 transactions. Details regarding payments to merchants 435 for card 100 transactions may be carried out according to any of a number of known methods. As depicted in Block 365, the card-issuer 425 may provide the charitable organization 430 with a periodic report on stored-value card 100 activity for a given reporting period.

Although not depicted explicitly in FIG. 3A, Blocks 340 and 345, Blocks 350 and 355, and Blocks 360 and 365 may cycle more than once in the course of the process 300. For example, regarding Block 340 and 345, the cardholder 405 may load the stored-value card 100 and may later reload the card 100 whenever the cardholder 405 wishes to replenish the funds represented by the stored value card 100 and to thereby make a contribution to the cardholder's specified beneficiary 430. In return, the card-issuer 425 continues to periodically provide accounting reports of the stored-value card 100 activity to the cardholder 405.

FIG. 3A depicts one embodiment of a process 300 for using a stored-value card system to provide a charitable donation to a cardholder's 405 specified beneficiary 430 based on value loaded to the card 100. The flowchart of FIG. 3A uses a set of sequenced blocks that represent various functions associated with the process 300. As will be familiar to one of ordinary skill in the art, other embodiments of a process 300 for using a stored-value card system to provide a charitable donation may be implemented with other configurations of blocks and/or other divisions of functions to be performed without departing from the intended spirit of the invention as described herein.

FIG. 3B is a flowchart illustrating one embodiment of a process 320 for accepting an enrollment form for a stored-value card 100, once terms of the stored-value card program have been agreed upon by the charitable organization 430 and the card-issuer 425. As depicted by Block 322, the card-issuer 425 and/or the charitable organization 430 solicit enrollment forms for the stored-value card program. For example, the charitable organization 430 may send mailers to its members or known donors, offering an option of donating using the stored-value card 100. Enrollment forms may be sent to organization members, who may then choose to enroll in the card program by communicating with the card-issuer 425 or, in some embodiments, with the charitable organization 430. Enrollment forms in the stored-value program may be approved more quickly and easily than credit card-type applications because the card-issuer 425 of the stored-value card 100 typically does not extend credit to the cardholder and has no need to assess the credit-worthiness of the enrollee. Approval of a stored-value card 100 enrollment form typically entails verifying that requested information for administering the card 100 has been provided by the enrollee.

As depicted in Block 324, the potential cardholder submits the enrollment form, which includes identification of the charitable organization 430 or other one or more specified beneficiaries to which the potential cardholder 405 may choose to have his or her rebate credited.

As depicted in Block 326, the card-issuer 425 processes and, barring obstacles, approves the cardholder's 405 enrollment form. One advantage of the stored-value card system for facilitating donations over credit-card-based systems is that the card-issuer 425 takes on less risk in issuing a stored-value card 100 and can therefore approve virtually all enrollment forms with greater speed and ease.

FIG. 3B depicts one embodiment of a process 320 for accepting an enrollment form for a stored-value card 100. The flowchart of FIG. 3B uses a set of sequenced blocks that represent various functions associated with the process 320. As will be familiar to one of ordinary skill in the art, other embodiments of a process 320 for accepting an enrollment form for a stored-value card system may be implemented with other configurations of blocks and/or other divisions of functions to be performed without departing from the intended spirit of the invention as described herein.

FIG. 3C is a flowchart illustrating one embodiment of a process 330 for creating accounts and database records for newly approved cardholders 405.

As depicted in block 332, after the cardholder's enrollment form is processed in Block 326 of FIG. 3B, the card-issuer 425 creates one or more database records 420 to store information about the cardholder account 440 and activity associated with use of the stored-value card 100. Completion of the enrollment process links the potential individual cardholder's account with the beneficiary recipient organization 430 so that intended charitable contributions may be routinely, systematically, and accurately routed to an associated charitable holding account. Linking may be accomplished by storing in the individual's cardholder account database record 420 an indication of the tax identification number of the charitable concern 430.

The cardholder 405 may further identify one or more checking accounts, savings accounts, or other accessible source of finds belonging to the cardholder that will be use as a source of funds for loading the stored-value card 100. The card-issuer 425 may verify the suitability of the source of funds as part of the enrollment process.

As depicted in Block 334, once the administrative tasks of the approval process have been completed, the card-issuer 425 issues a stored-Value card 100 to the cardholder. The card 100 may be sent by mail, may be distributed in person by the card-issuer 425, or may be distributed by the charitable organization 430 to members who have enrolled in and been approved for the stored-value card 100. Once the charitable concern 430 member's card 100 has been sent out and received by the individual, he or she is now in a position to make the card 100 functional by loading value onto the card 100, as depicted in Block 340 of FIG. 3A and as will be described in greater detail with reference to FIG. 4.

FIG. 3C is a flowchart illustrating one embodiment of a process 330 for creating accounts 440 and database records 420 for new cardholders 405. The flowchart of FIG. 3C uses a set of sequenced blocks that represent various functions associated with the process 330. As will be familiar to one of ordinary skill in the art, other embodiments of a process 330 for creating accounts and database records for new cardholders 405 may be implemented with other configurations of blocks and/or other divisions of functions to be performed without departing from the intended spirit of the invention as described herein.

FIG. 4 is a block diagram illustrating one embodiment of a system for issuing, using, and administering a stored-value card 100. The block diagram of FIG. 4 illustrates communications between the cardholder 405, a stored-value card 100 processing center 415, the card-issuer 425, the charitable concern 430, and the card-issuer's database of charity donation information 420. This diagram makes more readily apparent the specific steps and protocols of the processes depicted in FIGS. 3A, 3B, and 3C.

As described earlier, once the cardholder 405 has received the card 100, the card 100 may be loaded with monetary value to provide full functionality to the cardholder 405. The cardholder 405 may load value on the card 100 using an interface system 410 for authorizing a transfer of funds from a previously-identified source account to the special card-related account 440. In various embodiments, the cardholder 405 may also use the interface system 410 to add or delete source accounts, to make changes to the cardholder's 405 designated beneficiary 430 of the stored-value card 100, to make changes to cardholder contact information, to check on the current balance of value loaded onto the card, or to make changes to the agreed upon percentage rate of donation associated with loading the card.

In one embodiment, cardholders 405 may dial a toll-free telephone number and, using a PIN number or other security method, access an interactive voice response (IVR) system that allows the cardholder 405 to authorize a transfer of funds to the card-related account 440. Traditional operator-assisted telephone protocols may also be used to load the card 100 and to communicate with the card issuer 425 regarding the card 100. In another embodiment, cardholders 405 may access a secured web-based browser system 410 that allows the cardholder 405 to load the card 100 and to perform other card-related administrative transactions. The web-based browser system 410 may allow the cardholder 405 to select from between a plurality of specified beneficiaries, and may allow the cardholder 405 to apportion a value loaded among a plurality of specified beneficiaries. Self-serve kiosks may be configured to allow cardholders 405 to load funds onto their cards using a credit card, an electronic debit from an account held by the cardholder, or using other familiar methodologies. Other embodiments using other methods for loading value onto the card 100 will be apparent to one of ordinary skill in the art.

As further depicted in FIG. 4, communications 408, 413 illustrate the cardholder 405 initiating a transaction with the stored-value card processing center 415 through an interface 410. The stored-value card processing center 415 may or may not be maintained by the card-issuer 425. The interface 410 may comprise an internet web site, a traditional telephone, or any other interface that would allow the information discussed herein to be exchanged, The communications 408, 413 preferably include information such as a card-related personal identification number (“PIN”) that may be used to uniquely identify the cardholder 405.

The communications 411, 407 illustrate the stored-value card processing center 415 responding to the communications 408, 413 after verifying the identity of the cardholder 405. The communications 411, 407 preferably prompt the cardholder 405 for information on the transaction, including an amount of value to be loaded, a selection of a beneficiary or beneficiaries to be associated with the value loaded (if the cardholder 405 has more than one possible beneficiary), and a selection of an account from which to load the value (if the cardholder 405 has more than one possible account from which to draw funds). The source account of the cardholder 405 may be one or more of: existing checking, savings or brokerage accounts, existing credit card accounts, other secured value cards, or other available source of funds. For example, the cardholder 405 may use a money-wiring service such as Western Union to transfer funds or may send payment in by mail or facsimile machine, pay in person to a representative of the card-issuer 425, or use other methods well-known in the industry.

The communications 409, 414 illustrate the cardholder 405 providing the loading information to the stored-value card processing center 415. The communications 409, 414 preferably including an amount of value to be loaded, a selection of a beneficiary to be associated with the value loaded (if the cardholder 405 has more than one possible beneficiary), and a selection of a source account from which to load the value (if the cardholder 405 has more than one possible account from which to draw funds).

In one embodiment, the cardholder 405 may establish an automatic direct deposit for loading the stored-value card 100. For example, an employer may agree to deposit a portion of the cardholder's 405 paycheck into the cardholder's card-related account 440. Thus, communications with the stored-value card processing center 415 related to loading the card 100 may be undertaken by the employer on behalf of the cardholder 405.

Upon completion of the communications described above, the cardholder 405 is free to purchase goods and services using the stored-value card 100. As depicted in FIG. 4, the cardholder 405 may present the stored-value card 100 to a merchant 435 in association with a purchase transaction 423. The merchant 435 may communicate 429 with the card-issuer 425, or with a representative of the card-issuer, in order to verify a sufficiency of funds in the cardholder's card-related account 440. If the card-issuer 425 communicates 429 a positive verification, the merchant 435 may accept the stored-value card 100 for payment of the purchase and communicate 429 with the card-issuer 425 about completion of the transaction. The card-issuer 425 may communicate 421 with the card processing center 415 regarding the transaction, directing funds to be transferred from the cardholder's card-related account 440 to an account held by the merchant 435 and a record of the transaction to be entered into the cardholder's record in the stored-value card accounts database 420.

The card-issuer 425 communicates 421 with the stored-value card processing center 415 regarding

In the embodiment shown in FIG. 4, this transaction is recorded 417 in the cardholder's respective record in the database of charity donation information 420.

Once value is loaded onto the card 100 by cardholder 405, the card processing center 415 may also calculate and record the resultant charitable contribution in the bank database of charitable information 420. When the card processing center 415 is separate from the card-issuer 425, the card processing center 415 may communicate 421 with the issuing bank 425 regarding the loading, so that funds may be appropriately transferred to the designated charitable organization 430. 10063] Communication 427 illustrates a transfer of funds corresponding to the accrued charitable contribution from the card-issuer 425 to the charitable concern 430. The transfer 427 may be executed using a check, a wire transfer, or other electronic transmittal from the issuing bank 425 to the charitable concern 430. The transfer 427 may be executed following each transaction with a cardholder 405, or it may occur periodically or episodically as is well known in the industry.

The card issuer 425 or the card processing center 415 provides a periodic accounting of the charitable contributions to both the cardholder 405, as depicted in Block 345 of FIG. 3A and to the charitable concern 430, as depicted in Block 355 of FIG. 3A. Sample embodiments of the reports are provided in FIGS. 5 and 6 to follow. Information for generating the reports may be maintained in the bank database of charity donation information 420.

FIG. 5 depicts a simplified example of one embodiment of an individual charitable contribution report. The sample report in FIG. 5 provides the cardholder, John Smith, with information about his designated charity and contribution level, as well as his stored-value card activity for the report period of March 2004. The activity information comprises information about funds loaded onto the card 100 during the report period and a dollar amount of charitable contributions generated by the loading. Furthermore, the report provides summary year-to-date information about a total amount of funds loaded and a total dollar amount of funds contributed to the designated charity. A special report may be prepared annually for informing the cardholder 405 of tax-deductible contributions made within a given calendar year for inclusion in an income tax or other related form. As will be familiar to one of ordinary skill in the art, different items of information and different formats may also be used to prepare a report for a cardholder of a loadable stored-value card.

FIG. 6 depicts a simplified example of one embodiment of a group charitable contribution report. The sample report in FIG. 6 provides the charitable organization, St. Mary's of Seattle Church, with information about loadable stored-value card activity for the period that has resulted in donations to the charitable organization 430 for the report period of March 2004. The report provides information about a current number of contributors who have designated the charitable organization 430 as their specified beneficiary and about a percentage contribution level common to the donating cardholders 405. As described previously, in other embodiments a charitable organization 430 may have cardholders 405 making contributions from their stored-value cards at a variety of percentage levels. The activity information provided in the sample report of FIG. 6 comprises information about funds loaded onto stored-value cards 100 by cardholders 405 during the report period and a dollar amount of charitable contributions generated by the loading. Furthermore, the report provides summary year-to-date information about a total amount of funds loaded and a total dollar amount of funds received by the charity 430. As will be familiar to one of ordinary skill in the art, different items of information and different formats may also be used to prepare a report for a specified beneficiary 430 of a loadable stored-value card 100.

As is clear from the above description, the cardholder 405 may load a monetary amount onto the card 100 and know that an agreed-upon portion will be credited to the designated beneficiary. The cardholder 405 may then use the card 100 as he or she wishes as payment for a variety of transactions at his or her discretion. Furthermore, when the specified beneficiary 430 is an IRS-approved entity, the donated portion may be tracked and reported as a tax-deductible donation.

As is also clear, the card 100 provides an automatic and simple approach for ordinary people to make donations to a fundraising entity 430.

Although this invention has been described in terms of certain preferred embodiments, other embodiments that are apparent to those of ordinary skill in the art are also within the scope of this invention. Accordingly, the scope of the present invention is intended to be defined only by reference to the appended claims.

In the claims, which follow, reference characters used to denote process steps are provided for convenience of description only, and not to imply a particular order for performing the steps.

What is claimed is:

1. A method for facilitating donations from a population of participants to a specified fundraising beneficiary, comprising:
for each of a plurality of members from the population of participants: (a) providing the member with a loadable stored-value card associated with the member, the stored-value card being usable by the member when loaded to make purchases of goods and services from vendors, and (b) associating the loadable stored-value card with an account within which funds of the member may be stored and withdrawn; and
in response to a request received from a first member of the plurality of members: (c) placing funds into the account of the first member, thereby loading the loadable stored-value card of the first member with a first value, and (d) providing a second value to the specified fundraising beneficiary from the account of the first member.

2. The method of claim 1, wherein the second value provided to the specified fundraising beneficiary equals a predetermined percentage of the first value loaded in association with the loadable stored-value card of the first member.

3. The method of claim 1, wherein the specified fundraising beneficiary comprises a school.

4. The method of claim 1, wherein the specified fundraising beneficiary comprises a religious organization.

5. The method of claim 1, wherein the specified fundraising beneficiary comprises a savings account associated with the first member.

6. The method of claim 1, further comprising subsequently receiving additional funds from the member and placing those additional funds in the account of step (b) for the first member, thereby loading the loadable stored-value card of the first member with a third value, and (d) providing a fourth value to the specified fundraising beneficiary from the account of step (b) for the first member.

7. The method of claim 6, wherein receiving additional funds from the member comprises periodically receiving funds from an employer of the first member.

8. The method of claim 1, wherein the request received from a first member comprises receiving a communication from the first member via a secured website.

9. The method of claim 1, wherein the request received from a first member comprises receiving a communication from the first member via a telephone system.

10. The method of claim 1, further comprising sending a report to the first member, wherein the report summarizes information comprising the value loaded by the first member and the value provided to the specified fundraising beneficiary in association with the first member's stored-value card.

11. The method of claim 1, further comprising sending a report to the specified fundraising beneficiary, wherein the report summarizes information comprising the value provided to the specified fundraising beneficiary in association with the loading of funds for the first member's stored-value card.

12. A system for facilitating donations to a specified fundraising beneficiary by a population of participants, comprising:
a plurality of member accounts, wherein each member account is associated with (i) a member, and (ii) a stored-value card associated with that member, the stored-value card being usable generally by the member to make purchases of goods and services from vendors;
an interface for receiving requests from members of the population of participants; and
a stored-value card processor that, in response to a request from a member: (i) provides funds into the member's account, thereby loading the member's stored-value card with a first value; and (ii) provides a second value to the specified fundraising beneficiary from the member's account.

13. The system of claim 12, wherein the stored-value card processor determines the second value provided to the specified fundraising beneficiary as a predetermined percentage of the first value loaded in association with the member's stored-value card.

14. The system of claim 12, further comprising a database accessible to the stored-value card processor, wherein the database comprises data about each of the member accounts.

15. The system of claim 14, wherein the data about a member account comprises, for each loading of the stored-value card associated with the account, a record of a date on which the loading occurred and the value that was loaded in association with the stored-value card.

16. The system of claim 14, wherein the data about a member account comprises a record of an accrued monetary amount provided to the specified fundraising beneficiary from the member account.

17. The system of claim 12, wherein the stored-value card processor further calculates an accrued total amount provided into the member accounts.

18. The system of claim 12, wherein the stored-value card processor further calculates an accrued total amount provided to the specified fundraising beneficiary from the member accounts.

19. The system of claim 18, wherein the stored-value card processor further calculates an accrued total amount provided to the specified fundraising beneficiary from the member accounts during a predetermined time period.

20. The system of claim 19, wherein the predetermined time period is at least one of the set consisting of: monthly, quarterly, and annually.
